(19) United States
(12) Patent Application Publication
(10) Pub. No.: US 2011/0032057 A1
(43) Pub. Date: Feb. 10, 2011

(54) Waveguide and Assembly of Waveguide and Printed Circuit Board

(75) Inventors: CHIH JUNG LIN, Hsinchu City (TW); PING CHIN TSENG, Hsinchu City (TW)

Correspondence Address: WPAT, PC;INTELLECTUAL PROPERTY ATTORNEYS, 2030 MAIN STREET, SUITE 1300, IRVINE, CA, 92614, US

(73) Assignee: MICROELECTRONICS TECHNOLOGY INC., Hsinchu (TW)

(21) Appl. No.: 12/842,340

(22) Filed: Jul. 23, 2010

(30) Foreign Application Priority Data
Aug. 6, 2009 (TW) 098214522

(51) Int. Cl. H01P 3/12; H01P 1/04

(52) U.S. Cl. 333/248; 333/254

(57) ABSTRACT

A waveguide, configured to attach with a printed circuit board, includes a body, a waveguide channel, at least one flange portion, and a plurality of protrusions. The waveguide channel is formed through the body. The at least one flange portion is connected with an end portion of the body. The plurality of protrusions are disposed on a surface of the at least one flange portion and a surface of the end portion and abut against the surface of the printed circuit board.

### BACKGROUND OF THE INVENTION

1. Field of the Invention

The present invention relates to a waveguide and an assembly of a waveguide and a printed circuit board, and relates more particularly to a waveguide and an assembly of a waveguide and a printed circuit board having consistent communication quality.

2. Description of the Related Art

When a waveguide is connected with a printed circuit board or an electronic component and a gap exists between the end surface of the waveguide and the printed circuit board or the electronic component, or between the surface of the flange attached to the waveguide and the printed circuit board or the electronic component, reflective waves may be generated between the interfaces abutted against each other, resulting in increased return loss. Further, the gap may also attenuate transmitted signals, causing high insertion loss.

FIG. 1 shows an assembly including a conventional waveguide and a printed circuit board. Since the waveguide 12 is formed by a metal casting process, the end surfaces of the waveguide 12 and its flanges 122 are rough. After the cast is cooled, the shrinkage of the portion adjacent to the channel is different from the shrinkage of the portion adjacent to the periphery of the flanges 122. The difference in shrinkage may cause the warp of the surface of the flange 122 at the end of the waveguide 12. Further, the printed circuit board itself is not a flat plate-like object. The nonplanar characteristic of the printed circuit board 11 makes the control of the gap G formed between the waveguide 12 and the printed circuit board 11 difficult. As mentioned above, the gap G may cause return loss and insertion loss degradation, and the return loss and the insertion loss may also vary with the size of the gap G. In other words, the variation of the gap G in the assembly of the waveguide 12 and the printed circuit board 11 may change the performance of the assembly.

FIG. 2 is a frequency response graph showing the return loss and the insertion loss of the assembly of FIG. 1. In FIG. 2, three gaps of different widths (G=0.1 mm, 0.16 mm, and 0.22 mm) are considered. Clearly, in the operating frequency range the return losses S11 and the insertion losses S21 incurred by the three different gaps differ greatly. As a result, the communication quality of the assembly of the waveguide 12 and the printed circuit board 11 cannot be consistently maintained.

Thus, traditional waveguide and printed circuit board assemblies cannot have consistent communication quality. Therefore, a new waveguide and new microwave communication apparatus without the above-mentioned drawbacks are needed.

### SUMMARY OF THE INVENTION

The present invention proposes a waveguide and an assembly of a waveguide and a printed circuit board. A plurality of protrusions is disposed on the end surface of the waveguide or on a printed circuit board such that the issue of the large degradation of the return loss and the insertion loss caused by the gap formed between the waveguide and the printed circuit board can be overcome.

The present invention proposes a waveguide, which includes a body, a waveguide channel, at least one flange portion, and a plurality of protrusions. The waveguide channel is formed through the body. The at least one flange portion is connected with an end portion of the body. The plurality of protrusions are disposed on a surface of the at least one flange portion and a surface of the end portion.

The present invention proposes an assembly comprising a waveguide and a printed circuit board. The waveguide includes a body, a waveguide channel, and at least one flange portion. The waveguide channel is formed through the body. The at least one flange portion is connected with an end portion of the body. A plurality of protrusions are disposed on a surface of the printed circuit board, abutting against the surfaces of the at least one flange portion and the end portion.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 shows an assembly including a conventional waveguide and a printed circuit board;

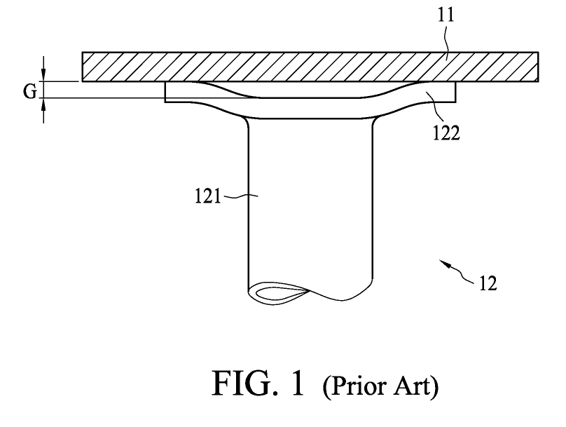

FIG. 2 is a frequency response graph showing the return loss and the insertion loss of the assembly of FIG. 1;

FIG. 3 is a view showing the assembly of a waveguide and a printed circuit board according to one embodiment of the present invention;

FIG. 4 is a frequency response graph showing the return loss and the insertion loss of the assembly of FIG. 3;

FIG. 5 shows a plurality of protrusions disposed on the end surface of a waveguide according to one embodiment of the present invention; and

FIG. 6 shows a plurality of protrusions disposed on the surface of a printed circuit board according to one embodiment of the present invention.

### DETAILED DESCRIPTION OF THE INVENTION

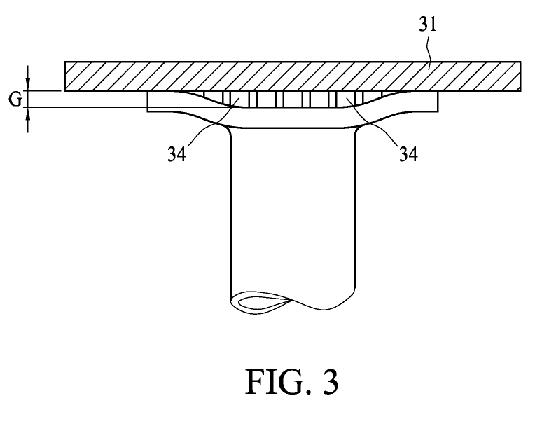

FIG. 3 is a view showing the assembly of a waveguide and a printed circuit board according to one embodiment of the present invention. A waveguide 32 and a printed circuit board 31 are configured to be assembled together. The microwave transmitted by the waveguide 32 can be received by and converted into electrical signals by the printed circuit board 31. A plurality of protrusions 34 are disposed in the gap G at the bonded interface between the waveguide 32 and the printed circuit board 31. The plurality of protrusions 34 can overcome the issue of the large degradation of the return loss and the insertion loss caused by the gap G between the waveguide 32 and the printed circuit board 31.

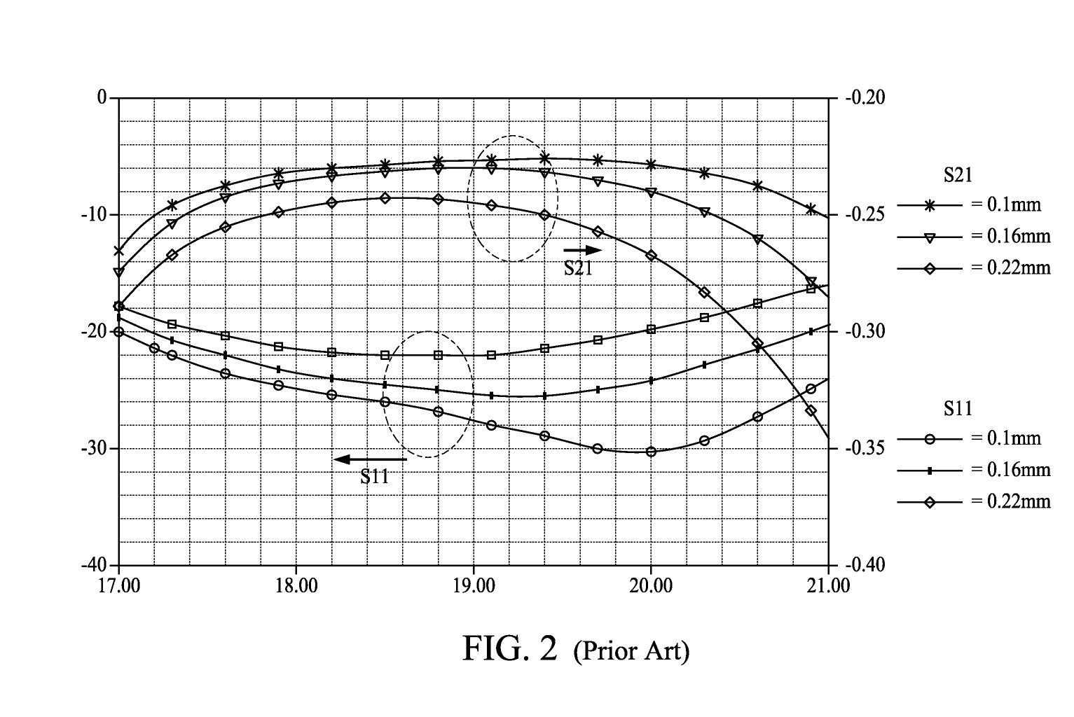

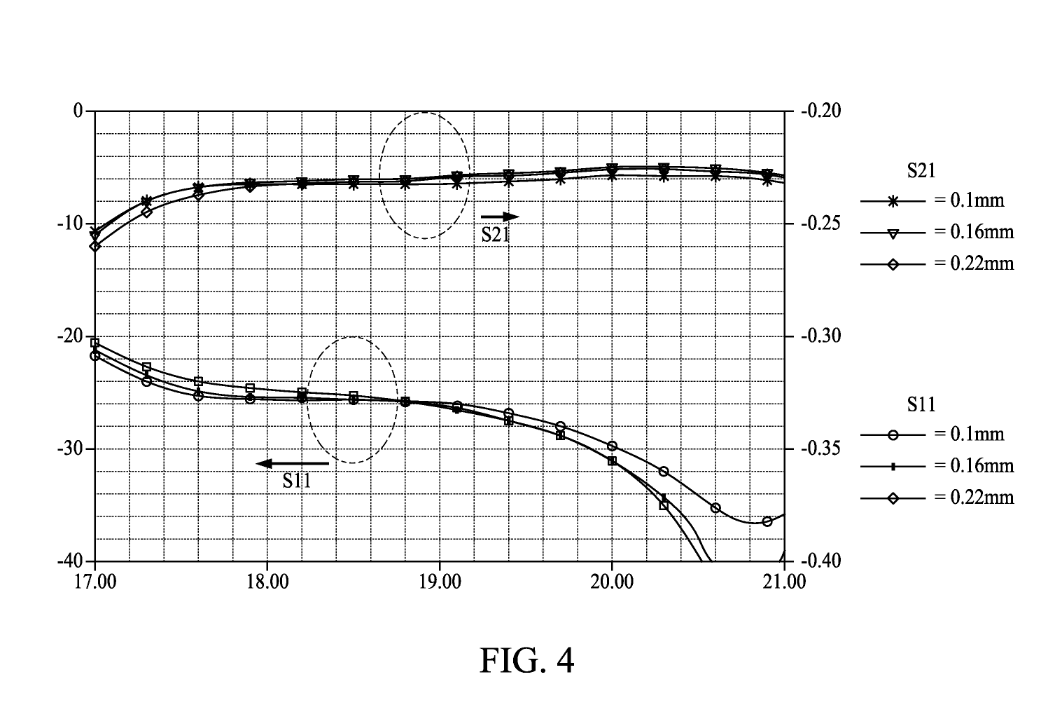

FIG. 4 is a frequency response graph showing the return loss and the insertion loss of the assembly of FIG. 3. In the embodiment of FIG. 3, three gaps G with different gap widths (G=0.1 mm, 0.16 mm, and 0.22 mm) are considered. Clearly, in the operating frequency range the return losses S11 and the insertion losses S21 incurred by the three different gaps G differ only slightly. Accordingly, the communication quality of the assembly of the waveguide 32 and the printed circuit board 31 can be consistently maintained in a normal operating frequency range. Compared to the prior art assembly of FIG. 2, the inventive features of the present invention indeed overcome the issue of the large degradation of the return loss and the insertion loss.

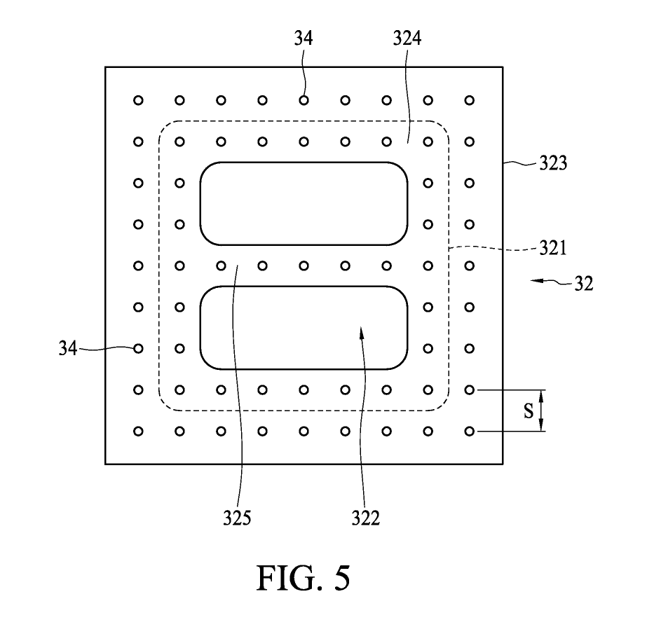

FIG. 5 shows a plurality of protrusions 34 disposed on the end surface of a waveguide 32 according to one embodiment of the present invention. The waveguide 32 comprises a body 321, a waveguide channel 322, and at least one flange portion 323. The waveguide channel 322 is formed through the body 321. The at least one flange portion 323 connects with a first end portion 324 of the body 321. The plurality of protrusions 34 is disposed on the surface of the at least one flange portion 323 and the surface of the first end portion 324, abutting against the surface of the printed circuit board 31.

In FIG. 5, the plurality of protrusions 34 are grouped into two annular rows surrounding the opening of the waveguide 32, wherein one annular row of the protrusions 34 is on the surface of the first end portion 324, while another annular row of the protrusions 34 is on the surface of the at least one flange portion 323. The plurality of protrusions 34 can also be arranged in a single annular row or in three or more annular rows.

In addition, a septum portion 325 can be formed to equally separate a portion of the waveguide channel 322. A row of protrusions 34 can be disposed on the end surface of the septum portion 325.

Preferably, two adjacent protrusions are separated from each other by a distance S of from 0.01λ to 0.5λ where λ is a wavelength of a central frequency of microwave transmitted by the waveguide channel 322.

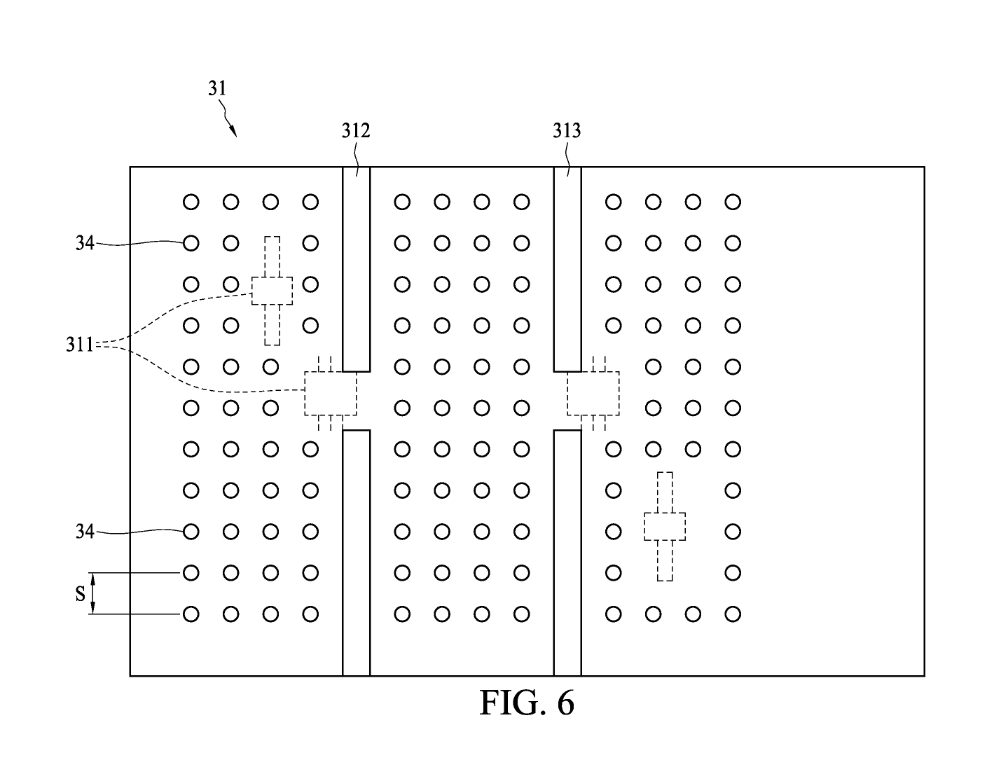

FIG. 6 shows a plurality of protrusions 34 disposed on the surface of a printed circuit board 31 according to one embodiment of the present invention. The plurality of protrusions 34 are arrayed in a matrix fashion. A plurality of electronic components 311 can be on the printed circuit board 31. The material of the protrusion 34 can be solder material. The plurality of protrusions 34 can be formed on the surface of the printed circuit board 31 using a screen printing process. Due to low hardness, the protrusions of solder material can allow the printed circuit board 31 and the waveguide 32 to engage with each other more closely, especially when the flatness of the surface at the bonded interface is poor. Other similar metal material can also be applied to allow the printed circuit board 31 and the waveguide 32 to engage with each other more closely.

The plurality of protrusions 34 can tightly abut against the surface of the waveguide 32. Thus, the issue of the large degradation of the return loss and the insertion loss can be overcome. Further, the plurality of protrusions 34 can function as a shield against EMI radiation. As such, the EMI radiation can be prevented from entering into the waveguide 32 and affecting the operation of the printed circuit board 31. In addition, the plurality of protrusions 34 can prevent the mutual interference of signals (“cross talking”) between the two signal traces 312 and 313.

The above-described embodiments of the present invention are intended to be illustrative only. Numerous alternative embodiments may be devised by persons skilled in the art without departing from the scope of the following claims.

What is claimed is:

1. A waveguide, comprising:
a body, including a first end portion;
a waveguide channel formed through the body;
at least one flange portion connected with the first end portion; and
a plurality of protrusions disposed on a surface of the at least one flange portion and a surface of the first end portion.

2. The waveguide of claim 1, wherein the plurality of protrusions are disposed on the surface of the at least one flange portion and the surface of the first end portion, surrounding the periphery of the waveguide channel.

3. The waveguide of claim 1, wherein the plurality of protrusions is arranged in at least one annular row surrounding the waveguide channel.

4. The waveguide of claim 1, further comprising a septum portion separating a portion of the waveguide channel into two equal parts.

5. The waveguide of claim 4, wherein a portion of the plurality of protrusions are disposed on an end surface of the septum portion.

6. The waveguide of claim 1, wherein two adjacent ones of the plurality of protrusions are separated from each other by a distance of from 0.01λ to 0.5λ where λ is a wavelength of a central frequency of microwave transmitted by the waveguide channel.

7. An assembly of a waveguide and a printed circuit board, comprising:
a waveguide comprising:
a body including a first end portion;
a waveguide channel formed through the body; and
at least one flange portion connected with the first end portion;
a printed circuit board comprising a plurality of protrusions disposed on a surface thereof, wherein the plurality of protrusions abut against a surface of the at least one flange portion and a surface of the first end portion.

8. The assembly of claim 7, wherein the plurality of protrusions are disposed on the surface of the at least one flange portion and the surface of the first end portion, surrounding the periphery of the waveguide channel.

9. The assembly of claim 7, wherein the plurality of protrusions is arranged in at least one annular row surrounding the waveguide channel.

10. The assembly of claim 7, wherein two adjacent ones of the plurality of protrusions are separated from each other by a distance of from 0.01λ to 0.5λ where λ is a wavelength of a central frequency of microwave transmitted by the waveguide channel.

11. The assembly of claim 7, wherein the protrusion includes solder material.

12. The assembly of claim 11, wherein the plurality of protrusions are formed using a screen printing process.

13. The assembly of claim 11, wherein the plurality of protrusions are arrayed on the surface of the printed circuit board.

14. The assembly of claim 11, wherein the plurality of protrusions are configured to prevent interference between two adjacent signal traces on the printed circuit board.
